(19) United States
(12) Patent Application Publication
(10) Pub. No.: US 2005/0137919 A1
(43) Pub. Date: Jun. 23, 2005

(54) Method, system, and storage medium for integrating return products into a forward supply chain manufacturing process

(75) Inventors: Jonathan D. Buckley, Raleigh, NC (US); Bruce M. Cody, Bethel, CT (US); Theodore F. Cook, Cary, NC (US); Dennis K. Hanson, Rochester, MN (US); Mary E. Helander, Brookline, MA (US); William F. Holden, Shell Lake, WI (US); Kevin P. O'Connor, Hyde Park, NY (US); Joseph Stehle, Trafford, PA (US); Pitipong Veerakamolmal, Brookline, MA (US); Chau-Jye Yang, Palo Alto, CA (US)

Correspondence Address: Philmore H. Colburn;Cantor Colburn LLP, 55 Griffin Road South, Bloomfield, CT, 06002, US

(73) Assignee: International Business Machine Corporation, Armonk, NY (US)

(21) Appl. No.: 10/740,643

(22) Filed: Dec. 19, 2003

(51) Int. Cl. G06F 17/60

(52) U.S. Cl. 705/7

(57) ABSTRACT

An exemplary embodiment of the invention relates to a method, system, and storage medium for integrating returned products into a forward supply chain manufacturing process. The method comprises forecasting returns for at least one product by quantity for a given time period. The product includes a product identifier. Based upon the forecasting returns, determining raw component supply for at least one constituent component of the at least one product utilizing a Bill of Material for the product and the product identifier. The method also includes analyzing raw component supply data in conjunction with supply suitability analysis data. The raw component supply comprises a component identifier, a potential quantity, and a time period operable for identifying when a component is anticipated to be available for return. Other embodiments of the invention include a system, and a storage medium.

### BACKGROUND

The present invention relates generally to manufacturing processes, and more particularly, the present invention relates to a method, system, and storage medium for integrating return products into a forward supply chain manufacturing process.

Manufacturing enterprises often receive returned goods from customers or entities that lease the goods for fixed time periods. Goods are sometimes returned for other reasons as well, such as when a retailer has an agreement with the manufacturer that unsold products will be purchased back by the manufacturer.

Advanced planning systems (APS) are used to optimize supply chain planning decisions. These systems leverage mathematical models (e.g., linear programs) to optimize planning decisions including the build plan for the manufactured parts (e.g., assemblies, subassemblies, components) at the manufacturing plants in a division, interplant logistics, and customer shipments. To determine the optimal plan, they trade off several criteria to determine an optimal allocation of limited work center capacity and material supply to best meet a prioritized customer demand statement. Criteria may include not only new supply availability data relating to raw materials but also supply availability of defective/reworkable products and their constituent components.

For industries with a significant amount of returned goods, it would be beneficial to provide detailed information concerning the returnable goods to the APS so that the returnable goods can be factored into the overall supply chain planning process, thus allowing these products and/or their components to be reused.

### SUMMARY

An exemplary embodiment of the invention relates to a method, system, and storage medium for integrating returned products into a forward supply chain manufacturing process. The method comprises forecasting returns for at least one product by quantity for a given time period. The product includes a product identifier. Based upon the forecasting returns, determining raw component supply for at least one constituent component of the at least one product utilizing a Bill of Material for the product and the product identifier. The method also includes analyzing raw component supply data in conjunction with supply suitability analysis data. The raw component supply comprises a component identifier, a potential quantity, and a time period operable for identifying when a component is anticipated to be available for return. Other embodiments of the invention include a system, and a storage medium.

An exemplary embodiment of a system for integrating returned products into a forward supply chain manufacturing process includes a host system in communication with at least one supply source via a communications network. The host system comprises a server executing an enterprise resource planning application, an advanced planning system application, and a rework application. The system also includes a reverse supply and demand system executing on the server and a data repository in communication with the server. The data repository stores at least one Bill of Material. The system also includes supply suitability analysis data relating to returning products. The reverse supply and demand system forecasts returns for at least one product by quantity for a given time period. The product includes a product identifier. Based upon the forecasting returns, the reverse supply and demand system determines raw component supply for at least one constituent component of the product utilizing a Bill of Material for the product and the product identifier. The reverse supply and demand system further analyzes raw component supply data in conjunction with the supply suitability analysis data.

### BRIEF DESCRIPTION OF THE DRAWINGS

Referred now to the drawings wherein like elements are numbered alike in the several FIGURES:

FIG. 1 is a block diagram of a portion of a system upon which the reverse supply and demand system is implemented in an exemplary embodiment;

FIG. 2 illustrates data fields of supply suitability analysis items that are analyzed by the reverse supply and demand system in an exemplary embodiment; and

FIG. 3 is a flowchart describing a process for implementing the reverse supply and demand system in an exemplary embodiment.

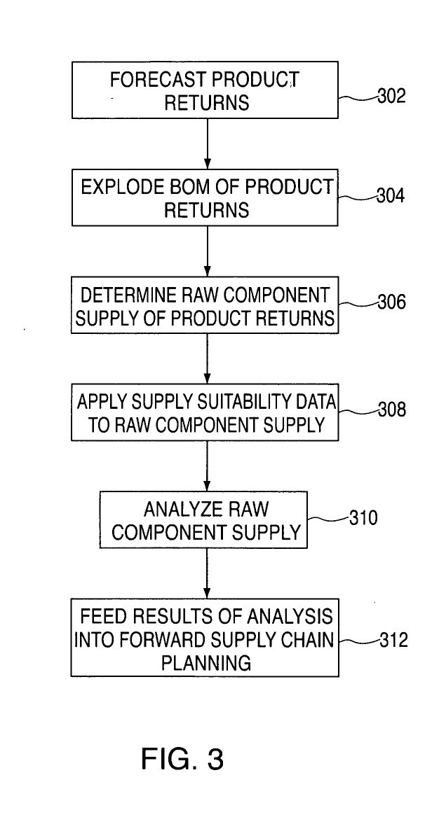

### DETAILED DESCRIPTION OF THE PREFERRED EMBODIMENT

The reverse supply and demand system of the present invention automates the forecast planning of product returns (e.g., machines, components, parts) received from a customer leasing enterprise environment or other product return processes. The reverse supply and demand system enables and automates business processes for planning and managing the reutilization of returning supply as a valid source of supply coverage to the current new build and used product demand supply planning process. This prevents or minimizes the purchase of new supply when used return supply is a viable available source of supply.

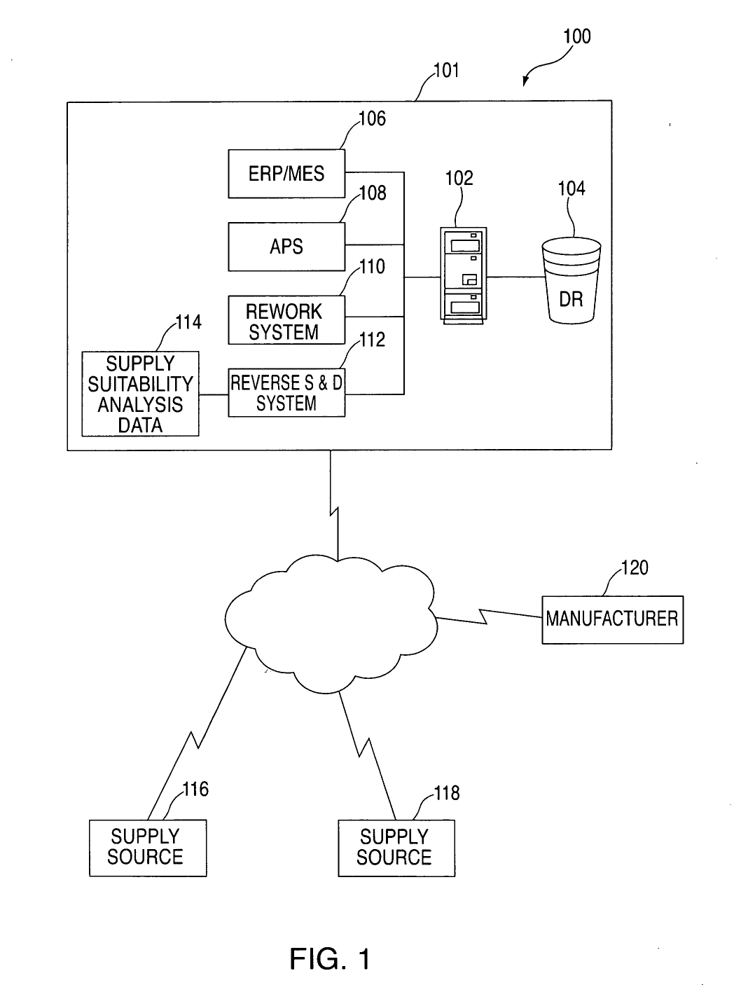

The reverse supply and demand system is implemented in a supply chain environment such as that depicted in the system of FIG. 1. Supply chain system 100 includes a host system 101 in communication with supply sources 116 and 118 as well as with manufacturer 120 via a communications network.

Host system 101 represents a manufacturing business enterprise. Host system 101 comprises a server 102 and a data repository 104 coupled together via a communication link such as network cabling. For illustrative purposes, server 102 is an IBM P690™ utilizing IBM's AIX™ operating system and DB2™ for data storage. Server 102 executes various business software applications typically associated with a manufacturing enterprise. Such software includes enterprise resource planning/manufacturing execution system software 106 and advanced planning system 108. In the supply chain system 100 of FIG. 1, server 102 is executing a rework system 110. The rework system 110 may comprise a tool such as the one described in U.S. patent application Ser. No. 10/610,948, entitled “Method, System, and Storage Medium for Integrating Rework Operations into an Advanced Planning Process”, filed on Jun. 30, 2003, and assigned to the assignees of the present invention. The above-referenced application is incorporated herein by reference in its entirety and refers to a tool that forecasts rework parametric information associated with a rework Bill of Materials flow and generates an integrated manufacturing plan utilizing the rework parametric information and the rework Bill of Materials flow.

The reverse supply and demand system 112 of the invention is also executed on server 102 and receives supply suitability analysis data 114 for evaluation as described further herein. Supply suitability analysis data fields receive data obtained via user input that is subsequently provided to the reverse supply and demand system 112. Supply suitability analysis data take into consideration factors such as the location of the returned products or parts, the cost and time associated with relocating the products or parts, and the costs and time associated with performing rework operations, building alternative products, and relocating oversupply of products or parts to locations that require them. This information is analyzed to determine optimum usage of returned products.

Data repository 104 stores BOM records for products. These BOM records are utilized by the reverse supply and demand system 112 to explode the returned products into their constituent parts as described further herein. Data repository 104 may comprise any form of mass storage device configured to read and write database type data maintained in a file store and is logically addressable as a consolidated data source across system 100. Information stored in data repository 104 is retrieved and manipulated via server 102. It will be understood that more than one server may be utilized by system 100 in order to accommodate a high volume of manufacturing activities typically generated in a large organization. Further data repository 104 and server 102 may comprise a single unit such as, for example, a mainframe computer.

As indicated above, current ERP systems used in a manufacturing process do not support returnable product planning. The reverse supply and demand system 112 of the invention includes supply suitability analysis data that allow for seamless integration of returned product data into an advanced manufacturing execution system's planning system.

Supply sources 116 and 118 may comprise entities that are sources of product returns. For example, supply source 116 may be a customer of host system 101 that receives products from host system 101 under a lease for a fixed period of time.

Manufacturer 120 refers to a division or manufacturing component of host system 101 that builds products for use by customers of host system 101.

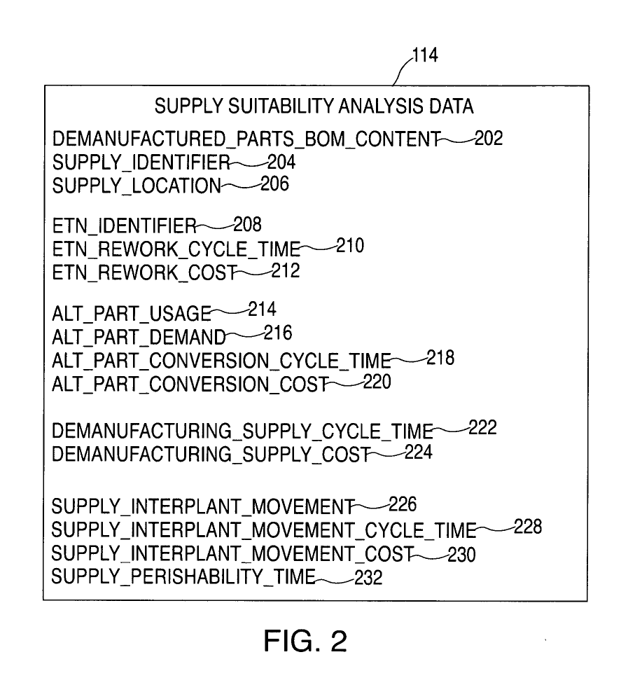

The supply suitability analysis data 114 provided in data fields 202-232 of the table depicted in FIG. 2 as used by the reverse supply and demand system 112 will now be described.

DEMANUFACTURED_PARTS_BOM_CONTENT 202 represents a data field that contains part numbers and quantities for each part or component of a returned product.

SUPPLY_IDENTIFIER 204 is a data field that contains a part number or identifier that is associated with a returned product.

SUPPLY_LOCATION 206 is a data field that refers to the location of the part or component.

ETN_IDENTIFIER 208 is a data field that corresponds to rework operations and indicates whether a rework process currently exists for a part associated with a returned product. ETN stands for Equivalent to New.

ETN_REWORK_CYCLE_TIME 210 is a data field that indicates the time allotted to rework operations for the part identified in field 208.

ETN_REWORK_COST 212 is a data field that indicates the cost involved in reworking the part identified in field 208.

ALT_PART_USAGE 214 is a data field that indicates whether a part can be used in an alternative product.

ALT_PART_DEMAND 216 is a data field that indicates the current demand for the part identified in field 214 as it relates to the alternative product.

ALT_PART_CONVERSION_CYCLE_TIME 218 is a data field that indicates the time allotted for performing alternative manufacturing operations for the part identified in field 214.

ALT_PART_CONVERSION_COST 220 is a data field that represents the cost involved in utilizing the part identified in field 214 for an alternative use.

DEMANUFACTURING_SUPPLY_CYCLE_TIME 222 is a data field that indicates the amount of time required to disassemble the return product before its constituent components may be used in manufacturing.

DEMANUFACTURING_SUPPLY_COST 224 is a data field that indicates the cost of disassembling the returned product identified in field 222.

SUPPLY_INTERPLANT_MOVEMENT 226 is a data field that indicates a location from where a part or component may be moved and a location to which the part or component may be sent. The relocation of parts may be for the purpose of performing ETN work, demanufacturing work, or to move oversupply parts or components to locations that express a demand for these parts or components.

SUPPLY_INTERPLANT_MOVEMENT_CYCLE_TIME 228 is a data field that indicates the time needed to transport the part or component between the locations addressed in field 226.

SUPPLY_INTERPLANT_MOVEMENT_COST 230 is a data field that indicates the cost of relocating the part or component addressed in field 226.

SUPPLY_PERISHABILITY_TIME 232 is a data field that indicates the anticipated longevity of a part or component.

The enterprise of host system 101 initiates the reverse supply and demand system process for returned goods by performing a forecast of anticipated product returns at step 302. This may be accomplished by examining all outstanding lease agreements and determining which products will be returned at a given time period. A product identifier is associated with the products for tracking purposes.

The Bills of Material (BOMs) in data repository 104 associated with these forecasted product returns are exploded into their constituent components at step 304.

At step 306, a raw component supply of product returns is determined based upon the results of step 304. The raw component supply includes information for each component of the returned product. The information includes a component identifier, a potential quantity of the component, and a time period indicating a time in which the component is anticipated to be available (e.g., expiration of lease).

At step 308, supply suitability analysis data 114 provided in data fields 202-232 of FIG. 2 are applied to the raw component supply information that was received from step 306. The raw component supply is analyzed in light of the supply suitability data 114 at step 310. The supply suitability data allows the enterprise of host system 101 to evaluate the trade-offs associated with each method of handling the returned components, such as the costs and cycle times associated with reworking a component, relocating a product or component, and utilizing the component in an alternative product. Trade-offs also factor in the time required for disassembling the returned products. In this manner, a business enterprise can easily perform cost-benefit analyses for the various options available for the returned products.

The results of the analysis are fed into APS 108 along with the current supply chain data at step 312. APS 108 is an advanced planning application and may comprise a linear programming model such as that described in U.S. Pat. No. 5,971,585, entitled “Best Can Do Matching of Assets With Demand in Microelectronics Manufacturing” which was issued on Oct. 26, 1999, assigned to the assignees of the present invention, and is incorporated by reference herein in its entirety. The above-referenced tool is a computer implemented decision support application that generates a “best can do” match between existing assets and demands within boundaries established by manufacturing specifications, process flows, and business policies to determine which demands can be met in a specified time period.

As can be seen by the above, the reverse supply and demand system automates business processes for planning and managing the reutilization of returning supply as a valid source of supply coverage to the current new build and used product demand supply planning process. This prevents or minimizes the purchase of new supply when used return supply is a viable available source of supply.

As described above, the present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While preferred embodiments have been shown and described, various modifications and substitutions may be made thereto without departing from the spirit and scope of the invention. Accordingly, it is to be understood that the present invention has been described by way of illustration and not limitation.

1. A method for integrating returned products into a forward supply chain manufacturing process, comprising:
forecasting returns for at least one product by quantity for a given time period, said product including a product identifier;
based upon said forecasting returns, determining raw component supply for at least one constituent component of said at least one product utilizing:
a Bill of Material for said at least one product; and
said product identifier; and
analyzing raw component supply data in conjunction with supply suitability analysis data;
wherein said raw component supply comprises:
a component identifier;
a potential quantity; and
a time period operable for identifying when a component is anticipated to be available for return.

2. The method of claim 1, wherein said analyzing said raw component supply data further includes:
determining options for re-using said raw component supply;
evaluating trade-offs associated with each of said options; and
selecting one of said option.

3. The method of claim 2, further comprising:
feeding raw component supply data associated with a selected option into an advanced planning system operable for generating an optimum manufacturing plan.

4. The method of claim 2, wherein said supply suitability analysis data include:
a location of said at least one constituent component;
information relating to a rework process that utilizes said at least one constituent component;
information relating to an alternative product for which said constituent component may be used;
information relating to disassembling a returned product that includes said constituent component; and
information relating to moving said constituent component from its current location to a location that is identified as having a need for said constituent component.

5. The method of claim 4, wherein said information relating to a rework process includes at least one of:
a time allotted to rework operations for said constituent component; and
a cost associated in said rework operations for said constituent component.

6. The method of claim 4, wherein said information relating to said alternative product for which said constituent component may be used includes at least one of:
an identification of said alternative product for which said constituent component may be used;
a demand for said constituent component as applied to said alternative product;
a time allotted for performing alternative manufacturing operations for said constituent component as applied to said alternative product; and
a cost involved in utilizing said constituent component for said alternative product.

7. The method of claim 4, wherein said information relating to said disassembling a returned product that includes said constituent component includes at least one of:
a time required to disassemble said returned product before said constituent component can be used in manufacturing; and
a cost associated with disassembling said returned product.

8. The method of claim 4, wherein said information relating to moving said constituent component from its current location to a location that is identified as having a need for said constituent component includes at least one of:
a first location from where said constituent component will be moved;
a second location to which said constituent component will be moved;
a time needed to transport said constituent component from said first location to said second location;
a cost of transporting said constituent component from said first location to said second location; and
an anticipated longevity of said constituent component.

9. The method of claim 1, wherein said forecasting returns for at least one product further comprises:
examining outstanding agreements relating to products identified as targeted for return; and
identifying an anticipated time period in which said products are targeted for return.

10. A storage medium encoded with machine-readable computer program code for integrating returned products into a forward supply chain manufacturing process, said storage medium including instructions for causing a server to implement a method, comprising:
forecasting returns for at least one product by quantity for a given time period, said product including a product identifier;
based upon said forecasting returns, determining raw component supply for at least one constituent component of said at least one product utilizing:
a Bill of Material for said at least one product; and
said product identifier; and
analyzing raw component supply data in conjunction with supply suitability analysis data;
wherein said raw component supply comprises:
a component identifier;
a potential quantity; and
a time period operable for identifying when a component is anticipated to be available for return.

11. The storage medium of claim 10, wherein said analyzing said raw component supply data further includes:
determining options for re-using said raw component supply;
evaluating trade-offs associated with each of said options; and
selecting one of said options.

12. The storage medium of claim 11, further comprising instructions for causing said server to implement:
feeding raw component supply data associated with a selected option into an advanced planning system operable for generating an optimum manufacturing plan.

13. The storage medium of claim 11, wherein said supply suitability analysis data include:
a location of said at least one constituent component;
information relating to a rework process that utilizes said at least one constituent component;
information relating to an alternative product for which said constituent component may be used;
information relating to disassembling a returned product that includes said constituent component; and
information relating to moving said constituent component from its current location to a location that is identified as having a need for said constituent component.

14. The storage medium of claim 13, wherein said information relating to a rework process includes at least one of:
a time allotted to rework operations for said constituent component; and
a cost associated in said rework operations for said constituent component.

15. The storage medium of claim 13, wherein said information relating to said alternative product for which said constituent component may be used includes at least one of:
an identification of said alternative product for which said constituent component may be used;
a demand for said constituent component as applied to said alternative product;
a time allotted for performing alternative manufacturing operations for said constituent component as applied to said alternative product; and
a cost involved in utilizing said constituent component for said alternative product.

16. The storage medium of claim 13, wherein said information relating to said disassembling a returned product that includes said constituent component includes at least one of:
a time required to disassemble said returned product before said constituent component can be used in manufacturing; and
a cost associated with disassembling said returned product.

17. The storage medium of claim 13, wherein said information relating to moving said constituent component from its current location to a location that is identified as having a need for said constituent component includes at least one of:
a first location from where said constituent component will be moved;
a second location to which said constituent component will be moved;
a time needed to transport said constituent component from said first location to said second location;
a cost of transporting said constituent component from said first location to said second location; and
an anticipated longevity of said constituent component.

18. The storage medium of claim 10, wherein said forecasting returns for at least one product further comprises:
examining outstanding agreements relating to products identified as targeted for return; and
identifying an anticipated time period in which said products are targeted for return.

19. A system for integrating returned products into a forward supply chain manufacturing process, comprising:
a host system in communication with at least one supply source via a communications network, said host system comprising:
a server executing:
an enterprise resource planning application;
an advanced planning system application; and
a rework application;
a reverse supply and demand system executing on said server;
a data repository in communication with said server, said data repository storing at least one Bill of Material;
supply suitability analysis data relating to returning products;
wherein said reverse supply and demand system performs:
forecasting returns for at least one product by quantity for a given time period, said product including a product identifier;
based upon said forecasting returns, determining raw component supply for at least one constituent component of said at least one product utilizing:
a Bill of Material for said at least one product; and
said product identifier; and
analyzing raw component supply data in conjunction with supply suitability analysis data.

20. The system of claim 19, wherein said raw component supply comprises:
a component identifier;
a potential quantity; and
a time period operable for identifying when a component is anticipated to be available for return

21. The system of claim 19, wherein said reverse supply and demand system further performs:
determining options for re-using said raw component supply as a result of said analyzing said raw component supply data;
evaluating trade-offs associated with each of said options; and
selecting one of said options.

22. The system of claim 21, wherein said raw component supply data associated with a selected option is fed into an advanced planning system operable for generating an optimum manufacturing plan.

23. The system of claim 20, wherein said supply suitability analysis data include:
a location of said at least one constituent component;
information relating to a rework process that utilizes said at least one constituent component;
information relating to an alternative product for which said constituent component may be used;
information relating to disassembling a returned product that includes said constituent component; and
information relating to moving said constituent component from its current location to a location that is identified as having a need for said constituent component.

24. The system of claim 23, wherein said information relating to a rework process includes at least one of:
a time allotted to rework operations for said constituent component; and
a cost associated in said rework operations for said constituent component.

25. The system of claim 23, wherein said information relating to said alternative product for which said constituent component may be used includes at least one of:
an identification of said alternative product for which said constituent component may be used;
a demand for said constituent component as applied to said alternative product;
a time allotted for performing alternative manufacturing operations for said constituent component as applied to said alternative product; and
a cost involved in utilizing said constituent component for said alternative product.

26. The system of claim 23, wherein said information relating to said disassembling a returned product that includes said constituent component includes at least one of:
a time required to disassemble said returned product before said constituent component can be used in manufacturing; and
a cost associated with disassembling said returned product.

27. The system of claim 23, wherein said information relating to moving said constituent component from its current location to a location that is identified as having a need for said constituent component includes at least one of:
a first location from where said constituent component will be moved;
a second location to which said constituent component will be moved;
a time needed to transport said constituent component from said first location to said second location;
a cost of transporting said constituent component from said first location to said second location; and
an anticipated longevity of said constituent component.

28. A system for integrating returned products into a forward supply chain manufacturing process, comprising:
a means for forecasting returns for at least one product by quantity for a given time period, said product including a product identifier;
a means for determining raw component supply for at least one constituent component of said at least one product based upon said forecasting returns, utilizing:
a Bill of Material for said at least one product; and
said product identifier; and
a means for analyzing raw component supply data in conjunction with supply suitability analysis data;
wherein said raw component supply comprises:
a component identifier;
a potential quantity; and
a time period operable for identifying when a component is anticipated to be available for return.

29. The system of claim 28, further comprising:
a means for determining options for re-using said raw component supply;
a means for evaluating trade-offs associated with each of said options; and
a means for selecting one of said options.

30. The system of claim 28, wherein said supply suitability analysis data include:
a location of said at least one constituent component;
information relating to a rework process that utilizes said at least one constituent component;
information relating to an alternative product for which said constituent component may be used;
information relating to disassembling a returned product that includes said constituent component; and
information relating to moving said constituent component from its current location to a location that is identified as having a need for said constituent component

30. The system of claim 28, wherein said supply suitability analysis data include:
a location of said at least one constituent component;
information relating to a network process that utilizes said at least one constituent component;
information relating to an alternative product for which said constituent component may be used;
information relating to disassembling a returned product that includes said constituent component, and
information relating to moving said constituent component from its current location to a location that is identified as having a need for said constituent component.
